(19) United States
(12) Patent Application Publication
(10) Pub. No.: US 2026/0045107 A1
(43) Pub. Date: Feb. 12, 2026

(54) SYSTEM AND METHOD FOR GENERATING SYNTHETIC IMAGE AND SEMANTIC SEGMENTATION MASK THEREOF

(71) Applicant: VINAI ARTIFICIAL INTELLIGENCE APPLICATION AND RESEARCH JOINT STOCK COMPANY, Ha Noi (VN)

(72) Inventors: Ho Quang Nguyen, Ha Noi (VN); Tuan Truong Vu, Ha Noi (VN); Tuan Anh Tran, Ha Noi (VN); Duc Minh Khoi Nguyen, Ha Noi (VN); Hai Hung Bui, Ha Noi (VN)

(21) Appl. No.: 18/956,815

(22) Filed: Nov. 22, 2024

(30) Foreign Application Priority Data
Aug. 9, 2024 (VN) 1-2024-05990

(51) Int. Cl. G06V 20/70; G06T 5/60; G06T 5/70; G06T 7/194; G06T 11/60; G06V 10/70; G06V 10/74; G06V 10/764; G06V 10/77; G06V 10/776; G06V 10/82

(52) U.S. Cl. CPC G06V 20/70; G06T 5/60; G06T 5/70; G06T 7/194; G06T 11/60; G06V 10/761; G06V 10/764; G06V 10/768; G06V 10/7715; G06V 10/776; G06V 10/82; G06T 2207/20021; G06T 2207/20081; G06T 2207/20084

(57) ABSTRACT

This application relates to a system and method for generating a synthetic image and a semantic segmentation mask thereof. The method for generating a synthetic image and a semantic segmentation mask thereof comprises generating, by a language model, a text prompt, wherein the text prompt comprises a caption and class labels; and generating, by a diffusion model, the synthetic image and the semantic segmentation mask thereof based on the text prompt.

### TECHNICAL FIELD

This application relates to a system and method for generating a synthetic image and a semantic segmentation mask thereof.

### BACKGROUND ART

Semantic segmentation is a fundamental task in computer vision. Its objective is to assign semantic labels to each pixel in an image, making it crucial for applications such as autonomous driving, scene comprehension, and object recognition. However, one of the primary challenges in semantic segmentation is the high cost associated with manual annotation. Annotating large-scale datasets with pixel-level labels is labor-intensive, time-consuming, and requires substantial human effort.

To address this challenge, an alternative strategy involves leveraging generative models to synthesize datasets with pixel-level labels. Past research efforts have utilized Generative Adversarial Networks (GANs) to effectively generate synthetic datasets for semantic segmentation, thereby mitigating the reliance on manual annotation. However, GAN models primarily concentrate on object-centric images and have yet to capture the intricate complexities present in real-world scenes.

On the other hand, text-to-image diffusion models have emerged as a promising technique for generating highly realistic images from textual descriptions. These models possess unique characteristics that make them well-suited for the generation of semantic segmentation datasets. Firstly, the text prompts used as input to these models can serve as valuable guidance since they explicitly specify the objects to be generated. Secondly, the application of self-attention and cross-attention maps in the image generation process endows these models with informative spatial cues, enabling precise extraction of object positions within the generated images.

By leveraging these characteristics of text-to-image diffusion models, the concurrent works Diffu-Mask and DiffusionSeg effectively generate pairs of synthetic images and corresponding segmentation masks. DiffuMask achieves this by utilizing straightforward text prompts, such as “a photo of a [class name][background description]”, to generate image and segmentation mask pairs. Meanwhile, DiffusionSeg focuses on creating synthetic datasets that address the challenge of object discovery, which involves identifying salient objects within an image. While these approaches successfully produce images paired with their corresponding segmentation masks, they are currently limited to generating a single object segmentation mask per image.

Thus, there is a need for a novel framework for generating realistic images depicting scenes with multiple objects, along with precise segmentation masks.

### DISCLOSURE OF INVENTION

It is an object of an embodiment of this application to propose a system and method for generating a synthetic image and a semantic segmentation mask thereof. The system and method comprising techniques: class-prompt appending, which encourages diverse object classes in the generated images, class-prompt cross-attention, which enables more precise attention to each object within the scene, and self-attention exponentiation, which is a simple refinement method using self-attention maps to enhance segmentation quality.

It is another object of an embodiment of this application to propose a semantic segmenter trained by the generated data using uncertainty-aware segmentation loss and self-training.

A first aspect of embodiment of this application provides a method for generating a synthetic image and a semantic segmentation mask thereof, comprising generating, by a language model, a text prompt, wherein the text prompt comprises a caption and class labels; and generating, by a diffusion model, the synthetic image and the semantic segmentation mask thereof based on the text prompt.

With reference to the first aspect of the embodiments of this application, in a first implementation of the first aspect of the embodiments of this application, the generating, by the diffusion model, the synthetic image and the semantic segmentation mask thereof based on the text prompt comprises: encoding, by a text encoder, the text prompt into a text embedding; and outputting, by the diffusion model, a final latent state reflecting a content encoded in the text embedding from an initial latent state after a predetermined number of denoising steps, wherein the diffusion model comprises a predetermined number of self-attention and cross-attention layers, at each denoising step, the self-attention and cross-attention layers transform a latent state of a current step to a latent state of a next step.

With reference to the first implementation of the first aspect of the embodiments of this application, in a second implementation of the first aspect of the embodiments of this application, the initial latent state follows N(0,1), standard Gaussian distribution.

With reference to the second implementation of the first aspect of the embodiments of this application, in a third implementation of the first aspect of the embodiments of this application, the transforming, at each denoising step, the latent state of the current step to the latent state of the next step comprises: generating, by each self-attention layer, a self-attention map for capturing a pairwise similarity between positions within a latent state of the current layer in order to enhance a local feature with a global context in a latent state of next layer; and generating, by each cross-attention layer, a cross-attention map for modeling the relationship between each position of the latent state of the current layer and each token of the text embedding so that the latent state of the next layer expresses more of the content encoded in the text embedding.

With reference to the third implementation of the first aspect of the embodiments of this application, in a fourth implementation of the first aspect of the embodiments of this application, the generating, by each cross-attention layer, the cross-attention map, comprises: generating a class-specific text prompt based on each class label; and generating the cross-attention map based on the class-specific text prompts.

With reference to the fourth implementation of the first aspect of the embodiments of this application, in a fifth implementation of the first aspect of the embodiments of this application, the method further comprises: averaging the cross-attention maps over layers and steps to generate an average cross-attention map; averaging the self-attention maps over layers and steps to generate an average self-attention map; and enhancing the average cross-attention map based on the average self-attention map.

With reference to the fifth implementation of the first aspect of the embodiments of this application, in a sixth implementation of the first aspect of the embodiments of this application, the enhancing the average cross-attention map based on the average self-attention map comprises: powering the average self-attention map to a predetermined exponent to generate a powered self-attention map; and multiplying the powered self-attention map to the average cross-attention map to generate an enhanced cross-attention map.

With reference to the sixth implementation of the first aspect of the embodiments of this application, in a seventh implementation of the first aspect of the embodiments of this application, the method further comprises: generating an objectness matrix based on the enhanced cross-attention map, wherein the objectness matrix comprises an objectness value at each location, wherein the higher the objectness value, the more likely that location contains an object; and generating a segmentation matrix based on the enhanced cross-attention map, wherein the segmentation matrix comprises a segmentation value at each location indicating which objects in the class labels that each location could be.

With reference to the seventh implementation of the first aspect of the embodiments of this application, in an eighth implementation of the first aspect of the embodiments of this application, the generating the semantic segmentation mask comprises, at a location in the objectness matrix: determining whether the objectness value of the location is less than or equal to a first threshold, in response to determining the objectness value of the location is less than or equal to the first threshold, setting a label of the location to background; determining whether the objectness value of the location is greater than or equal to a second threshold, wherein the second threshold is greater than the first threshold, in response to determining the objectness value of the location is greater than or equal to the second threshold, setting the label of the location to a class of the corresponding location of the segmentation matrix; and determining whether the objectness value of the location is greater than the first threshold and less than the second threshold, in response to determining the objectness value of the location is greater than the first threshold and less than the second threshold, setting the label of the location to uncertainty.

With reference to the eighth implementation of the first aspect of the embodiments of this application, in a ninth implementation of the first aspect of the embodiments of this application, the method further comprises: training a semantic segmenter Φ based on the generated synthetic image I and the semantic segmentation mask [symbol] thereof with an uncertainty-aware cross-entropy loss, wherein for pixels marked as uncertain, ignoring the loss from those as: [symbol] =Σₓ [symbol] ( [symbol] ₓ≠U) [symbol] _{CE}( [symbol] ₓ, [symbol] ₓ), where [symbol] is an indication function, [symbol] _{CE} is a cross entropy loss, and [symbol] ₓ=Φ(I) is the predicted segmentation from the synthetic image I; predicting, by the semantic segmenter, on synthetic image I as pseudo labels [symbol] * without uncertainty value U; and training the semantic segmenter based on pseudo labels [symbol] * to generate a final semantic segmenter Φ*.

A second aspect of embodiment of this application provides a system for generating a synthetic image and a semantic segmentation mask thereof comprising: one or more processors; and a computer-readable medium having instructions stored there on, which, when executed by the one or more processors, cause the system to perform operations comprising: generating, by a language model, a text prompt, wherein the text prompt comprises a caption and class labels; and generating, by a diffusion model, the synthetic image and the semantic segmentation mask thereof based on the text prompt.

With reference to the second aspect of the embodiments of this application, in a first implementation of the second aspect of the embodiments of this application, the generating, by the diffusion model, the synthetic image and the semantic segmentation mask thereof based on the text prompt comprises: encoding, by a text encoder, the text prompt into a text embedding; and outputting, by the diffusion model, a final latent state reflecting a content encoded in the text embedding from an initial latent state after a predetermined number of denoising steps, wherein the diffusion model comprises a predetermined number of self-attention and cross-attention layers, at each denoising step, the self-attention and cross-attention layers transform a latent state of a current step to a latent state of a next step.

With reference to the first implementation of the second aspect of the embodiments of this application, in a second implementation of the second aspect of the embodiments of this application, the transforming, at each denoising step, the latent state of the current step to the latent state of the next step comprises: generating, by each self-attention layer, a self-attention map for capturing a pairwise similarity between positions within a latent state of the current layer in order to enhance a local feature with a global context in a latent state of next layer; and generating, by each cross-attention layer, a cross-attention map for modeling the relationship between each position of the latent state of the current layer and each token of the text embedding so that the latent state of the next layer expresses more of the content encoded in the text embedding.

With reference to the second implementation of the second aspect of the embodiments of this application, in a third implementation of the second aspect of the embodiments of this application, the generating, by each cross-attention layer, the cross-attention map, comprises: generating a class-specific text prompt based on each class label; and generating the cross-attention map based on the class-specific text prompts.

With reference to the third implementation of the second aspect of the embodiments of this application, in a fourth implementation of the second aspect of the embodiments of this application, the instructions further cause the system to perform the operations of: averaging the cross-attention maps over layers and steps to generate an average cross-attention map; averaging the self-attention maps over layers and steps to generate an average self-attention map; and enhancing the average cross-attention map based on the average self-attention map.

With reference to the fourth implementation of the second aspect of the embodiments of this application, in a fifth implementation of the second aspect of the embodiments of this application, the enhancing the average cross-attention map based on the average self-attention map comprises: powering the average self-attention map to a predetermined exponent to generate a powered self-attention map; and multiplying the powered self-attention map to the average cross-attention map to generate an enhanced cross-attention map.

With reference to the fifth implementation of the second aspect of the embodiments of this application, in a sixth implementation of the second aspect of the embodiments of this application, the instructions further cause the system to perform the operations of: generating an objectness matrix based on the enhanced cross-attention map, wherein the objectness matrix comprises an objectness value at each location, wherein the higher the objectness value, the more likely that location contains an object; and generating a segmentation matrix based on the enhanced cross-attention map, wherein the segmentation matrix comprises a segmentation value at each location indicating which objects in the class labels that each location could be.

With reference to the sixth implementation of the second aspect of the embodiments of this application, in a seventh implementation of the second aspect of the embodiments of this application, the generating the semantic segmentation mask comprises, at a location in the objectness matrix: determining whether the objectness value of the location is less than or equal to a first threshold, in response to determining the objectness value of the location is less than or equal to the first threshold, setting a label of the location to background; determining whether the objectness value of the location is greater than or equal to a second threshold, wherein the second threshold is greater than the first threshold, in response to determining the objectness value of the location is greater than or equal to the second threshold, setting the label of the location to a class of the corresponding location of the segmentation matrix; and determining whether the objectness value of the location is greater than the first threshold and less than the second threshold, in response to determining the objectness value of the location is greater than the first threshold and less than the second threshold, setting the label of the location to uncertainty.

With reference to the seventh implementation of the second aspect of the embodiments of this application, in an eighth implementation of the second aspect of the embodiments of this application, the instructions further cause the system to perform the operations of: training a semantic segmenter Φ based on the generated synthetic image I and the semantic segmentation mask [symbol] thereof with an uncertainty-aware cross-entropy loss, wherein for pixels marked as uncertain, ignoring the loss from those as: [symbol] =Σₓ [symbol] ( [symbol] ₓ≠U) [symbol] _{CE}( [symbol] ₓ, [symbol] ₓ), where [symbol] is an indication function, [symbol] _{CE} is a cross entropy loss, and [symbol] ₓ=Φ(I) is the predlcted segmentation from the synthetic image I; predicting, by the semantic segmenter, on synthetic image I as pseudo labels [symbol] * without uncertainty value U; and training the semantic segmenter based on pseudo labels [symbol] * to generate a final semantic segmenter Φ*.

A third aspect of embodiment of this application provides a non-transitory computer-readable storage medium comprising instructions that, when executed by at least one processor of a machine, cause the machine to perform the method of the first aspect.

### BRIEF DESCRIPTION OF DRAWINGS

To describe the technical solutions in the embodiments of this application more clearly, the following briefly describes the accompanying drawings in the embodiments. Apparently, the accompanying drawings in the following description show only some embodiments of this application.

FIG. 1 is an overview diagram of an embodiment of a method for generating a synthetic image and a semantic segmentation mask thereof according to an embodiment of this application.

FIG. 2 is a schematic diagram of an embodiment of a method for generating a synthetic image and a semantic segmentation mask thereof according to an embodiment of this application.

FIG. 3 illustrates common issues of using provided or generated captions.

FIG. 4A illustrates results of an embodiment of a method for generating a synthetic image and a semantic segmentation mask thereof according to an embodiment of this application.

FIG. 4B illustrates correlation maps at some positions with others, extracted from a self-attention map.

FIG. 5A illustrates synthetic images and semantic segmentation masks of an embodiment of a method for generating a synthetic image and a semantic segmentation mask thereof according to an embodiment of this application.

FIG. 5B illustrates Segmentation results on VOC's validation set.

### BEST MODE(S) FOR CARRYING OUT THE INVENTION

For purposes of description herein, it is to be understood that the disclosed system and the related methods may assume various alternative embodiments and orientations, except where expressly specified to the contrary. It is also to be understood that the specific devices and processes illustrated in the attached drawings, and described in the following specification, are simply exemplary embodiments of the inventive concepts defined in the appended claims. While various aspects of the system and the related methods are described with reference to a particular illustrative embodiment, the disclosed invention is not limited to such embodiments, and additional modifications, applications, and embodiments may be implemented without departing from the disclosed invention. Hence, specific dimensions and other physical characteristics relating to the embodiments disclosed herein are not to be considered as limiting, unless the claims expressly state otherwise.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, the singular forms “a,” “an” and “the” are intended to include the plural forms as well, unless the context clearly indicates otherwise.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

The expression “configured to (or set to)” as used herein may be used interchangeably with “suitable for,” “having the capacity to,” “designed to,” “adapted to,” “made to,” or “capable of” according to a context. The term “configured to (set to)” does not necessarily mean “specifically designed to” in a hardware level. Instead, the expression “apparatus configured to?” may mean that the apparatus is “capable of?” along with other devices or parts in a certain context. For example, “a processor configured to (set to) perform A, B, and C” may mean a dedicated processor (e.g., an embedded processor) for performing a corresponding operation, or a generic-purpose processor (e.g., a CPU or an application processor) capable of performing a corresponding operation by executing one or more software programs stored in a memory device.

The term “module” as used herein may be defined as, for example, a unit including one of hardware, software, and firmware or two or more combinations thereof. The term “module” may be interchangeably used with, for example, the terms “unit”, “logic”, “logical block”, “component”, or “circuit”, and the like. The “module” may be a minimum unit of an integrated component or a part thereof. The “module” may be a minimum unit performing one or more functions or a part thereof. The “module” may be mechanically or electronically implemented. For example, the “module” may include at least one of an application-specific integrated circuit (ASIC) chip, field-programmable gate arrays (FPGAs), or a programmable-logic device, which is well known or will be developed in the future, for performing certain operations.

To facilitate understanding of the embodiments of this application, the following first briefly describes general concepts related to the semantic segmentation technique.

Semantic segmentation is a critical computer vision task that involves classifying each pixel in an image to a specific class label. Popular semantic segmentation approaches include the fully convolutional network (FCN) and its successors, such as DeepLab, DeepLabV2, DeepLabv3, DeepLabv3+, UNet, SegNet, PSPNet, and HRNet. Recently, transformer-based approaches like SETR, Segmenter, SegFormer, and Mask2Former have gained attention for their superior performance over convolution-based approaches. In the embodiments of this application, the generating synthetic datasets that can be used with any semantic segmenter is focused, so DeepLabv3 and Mask2Former may be used as they are commonly used.

Text-to-image diffusion models have revolutionized image generation research, moving beyond simple class-conditioned to more complex text-conditioned image generation. Examples include GLIDE, Imagen, Stable Diffusion (SD), Dall-E, eDiff-I, and Muse. These models can generate images with multiple objects interacting with each other, more closely resembling real-world images rather than the single object-centric images generated by prior generative models. The embodiments of this application mark a milestone in synthetic dataset generation literature, moving from image-level annotation to pixel-level annotation. Stable Diffusion may be used in the embodiments of this application.

Diffusion models for segmentation. Diffusion models have proven effective for semantic, instance, and panoptic segmentation tasks. These models either use input images to condition the mask-denoising process, or employ pretrained diffusion models as feature extractors. However, they still require ground-truth (GT) segmentation for training. In contrast, the embodiments of this application utilizes only a pretrained SD to generate semantic segmentation without GT labels.

Generative Adversarial Networks (GANs) for synthetic segmentation datasets. GANs have been employed in the generation of synthetic segmentation datasets, as demonstrated in previous works. However, these approaches primarily focus on object-centric images, where a single mask is segmented for the salient object or specific parts of common objects like faces, cars, or horses. In contrast, the embodiments of this application is designed to generate semantic segmentations for more complex images, where multiple objects interact with each other at the scene level. Furthermore, while some techniques support foreground/background subtraction, and others still require human annotations, the objective of the embodiments of this application is to generate semantic segmentations for multiple object classes in each image without the need for human involvement.

Diffusion models for synthetic data generation have been used to improve the performance of image classification, domain adaptation for classification, and zero/few-shot learning. However, these methods produce only image-level annotations as augmentation datasets. In contrast, the embodiments of this application produces pixel-level annotations, which is considerably more challenging.

Recently, there have been concurrent works that utilize Stable Diffusion (SD) for generating object segmentation without any annotations. However, they focus on segmenting a single object in an image rather than multiple objects. Their text-prompt inputs to SD are simple, usually “a photo of a [class name]”. The semantic segmenter trained on these annotations can segment multiple objects to some extent. The embodiments of this application, on the other hand, employs more complex text prompts where multiple objects can coexist and interact, making it more suitable for the semantic segmentation task in real-world images.

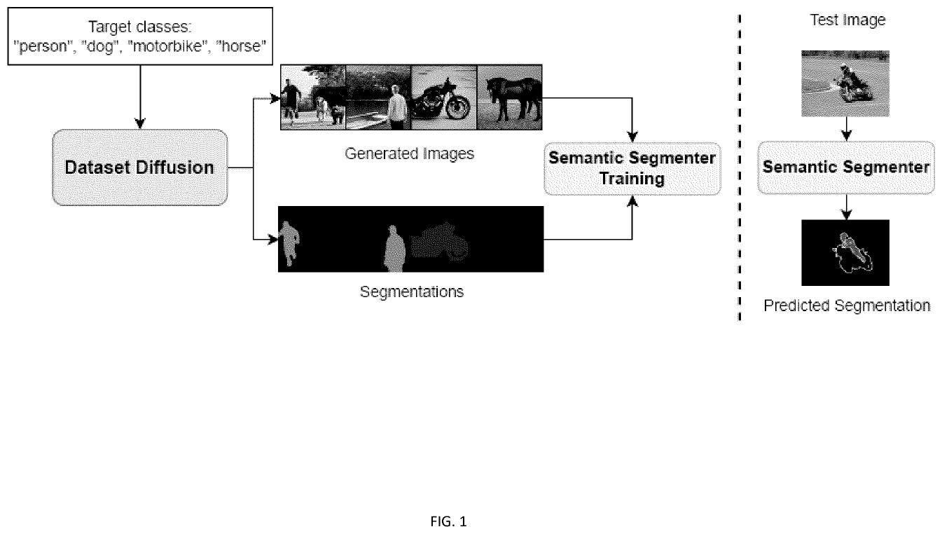

FIG. 1 is an overview diagram of an embodiment of a method for generating a synthetic image and a semantic segmentation mask thereof according to an embodiment of this application.

See the left part of FIG. 1, given the target classes, the embodiments of this application generates high-fidelity images with their corresponding pixel-level semantic segmentations. These segmentations serve as pseudo-labels for training a semantic segmenter. See the right part of FIG. 1, the trained semantic segmenter is able to predict the semantic segmentation of a test image.

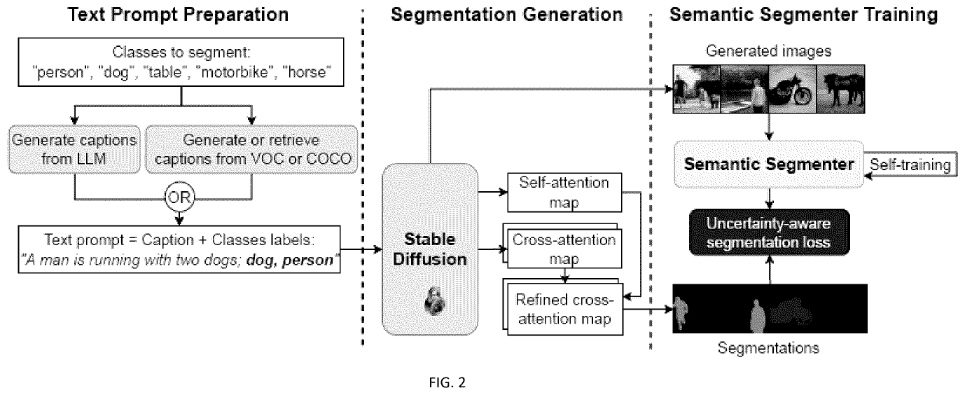

FIG. 2 is a schematic diagram of an embodiment of a method for generating a synthetic image and a semantic segmentation mask thereof according to an embodiment of this application.

With reference to FIG. 2, the objective of the embodiments of this application is to generate a synthetic dataset D=(Iᵢ, Sᵢ)ᵢ₌₁^{N}, consisting of high-fidelity images I and pixel-level semantic segmentation masks S. These images and masks capture both the semantic and location information of the target classes C={c₁, c₂, . . . , c_{K}}, where K represents the number of classes. The purpose of constructing this dataset is to train a semantic segmenter (without relying on human annotation.

In the embodiments of this application, a three-step process is proposed. Firstly, relevant text prompts P containing the target classes is prepared. Secondly, using Stable Diffusion (SD) as diffusion model, images Iᵢ ∈ R^{H×W×3} and their corresponding semantic segmentations Sᵢ ∈{0, . . . , K}^{H×W} are generated, where 0 represents the background class. These images and segmentations form the synthetic dataset D. Lastly, a semantic segmenter Φ is trained on the dataset D and evaluate its performance on the test set of standard semantic segmentation datasets. It is worth noting that the embodiments of this application primarily focuses on segmenting common objects in everyday scenes, where the SD model excels, rather than specialized domains like medical or aerial images.

In the first stage, the target classes are provided, and text prompts are generated using language models such as ChatGPT. Real captions (for COCO) or image-based captions (for VOC) can also be used for prompt generation to ensure standard evaluation. The text prompts are then augmented with the target class labels to avoid missing objects.

To prepare prompts containing a given list of classes for SD, one option is to utilize a large language model (LLM) such as ChatGPT to generate the sentences, similar to the method described in. This approach can be valuable in real-world applications.

However, for evaluating the quality of the synthetic dataset, the embodiments of this application need to rely on standard datasets for semantic segmentation like PASCAL VOC or COCO to create standardized benchmarks. In this regard, the embodiments of this application propose using the provided or generated captions of the training images in these datasets as the text prompts for SD. This is solely for the purpose of standard benchmarking where the text prompts are fixed, and the embodiments of this application do not utilize real images or image-label associations in synthetic dataset generation. These new benchmarks are called synth-VOC and synth-COCO.

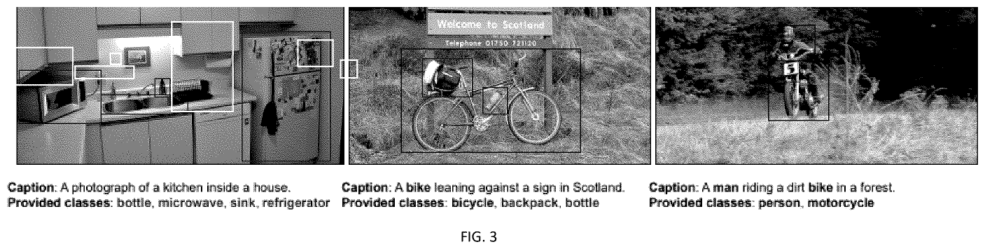

When using the COCO dataset, the embodiments of this application can rely on the provided captions to describe the training images. However, in the case of the PASCAL VOC dataset, which lacks captions, the embodiments of this application employ an image captioner like BLIP to generate captions for each image. However, the embodiments of this application encountered several issues with the provided or generated captions. Firstly, the text prompts may not use the exact terms as the target class names C provided in the dataset. For instance, terms like “man” and “woman” may be used instead of “person”, or “bike” instead of “bicycle”, resulting in a mismatch with the target classes. Secondly, many captions do not contain all the classes that are actually present in the images. As illustrated in FIG. 3, white classes are often missing from the captions, resulting in a lack of text prompts for those classes. Black classes may have different terms used in the captions, causing a discrepancy between the target class names and the text prompts. This leads to a shortage of text prompts for certain classes, affecting the generation process for those particular classes.

To address the issues, the embodiments of this application propose a method that leverages the class labels provided by the datasets. The embodiments of this application append the provided (or generated) captions Pᵢ with the class labels, creating new text prompts P′ᵢ that explicitly incorporate all the target classes Cᵢ=[c₁; . . . ; c_{M}], where M is the number of classes in image i. This is achieved through the text appending operation or class-prompt appending technique: P′ᵢ=[Pᵢ; Cᵢ]. For example, in the case of the left image in FIG. 3, the final text prompt would be “a photograph of a kitchen inside a house; bottle microwave sink refrigerator”. This ensures that the new text prompts encompass all the target classes, addressing the issue of mismatched or missing class names in the captions.

In the second stage, given the augmented text prompt, a frozen Stable Diffusion may be employed to generate an image and its self- and cross-attention maps. The cross-attention map for each target class is refined using the self-attention map to match the object's shape.

The embodiments of this application build a segmentation generator on Stable Diffusion (SD) by leveraging its self-attention and cross-attention layers. Given a text prompt P′ first encoded by a text encoder into text embedding e ∈ R^{∀×de} with the text length ∀ and the number of dimensions dₑ, SD seeks to output the final latent state z₀ ∈ R^{H×W×dz}, where H, W, d_{z} are height, width, and number of channels of z₀, reflecting the content encoded in e from the initial latent state z_{T}˜N (0, I) after T denoising steps.

At each denoising step t, a UNet architecture with L layers of self-attention and cross-attention is used to transform zₜ to zₜ₋₁. In particular, at layer l and time step t, the self-attention layer captures the pairwise similarity between positions within a latent state zₜ^{l} in order to enhance the local feature with the global context in

$${z}_{{t}^{l + 1}} .$$

In the meantime, the cross-attention layer models the relationship between each position of the latent state zₜ^{l} and each token of the text embedding e so that

$${z}_{{t}^{l + 1}}$$

can express more of the content encoded in e.

Formally, the self-attention map A_{S}^{l,t} ∈ [0, 1]^{HW×HW} and cross-attention map

$${A}_{{C}^{l , t}}$$

∈[0, 1]^{HW×∀} at layer l and time step t are computed as follows:

$${𝒜}_{𝒮}^{l , t} = Soft max ( \frac{{Q}_{z} {K}_{z}^{T}}{\sqrt{{d}_{l}}} ) , {𝒜}_{𝒞}^{l , t} = Soft max ( \frac{{Q}_{z} {K}_{e}^{T}}{\sqrt{{d}_{l}}} ) , \qquad ( 1 )$$

where Q_{z}, K_{z}, Kₑ are the query of z, key of z, and key of e, respectively, obtained by linear projections and taken as inputs to the attention mechanisms, and dₗ is # features at layer 1.

Since the embodiments of this application only want to obtain the cross-attention map of the class labels Cᵢ of image i for semantic segmentation, the embodiments of this application introduce class-prompt cross-attention that is similar to cross-attention in Eq. (1) but produced by only taking the softmax over the class name part Cᵢ rather than entire of the text prompt P′ᵢ. In practice, the embodiments of this application form a new text prompt \hat{P}ᵢ=Cᵢ just for the purpose of extracting the cross-attention maps while the original text prompt P′ᵢ for generating images keeps unchanged. After this, the embodiments of this application obtain A_{C}^{l,t} ∈ [0, 1]^{HW×M}, where M is the number of classes in the image.

With the observation that using different ranges of denoising steps only affects the final result marginally, the embodiments of this application average these self-attention and cross-attention maps over layers and denoising steps:

$${𝒜}_{𝒮} = \frac{1}{L \times T} {\sum }_{l = 1}^{L} {\sum }_{t = 0}^{T} {𝒜}_{𝒮}^{l , t} , {𝒜}_{𝒞} = \frac{1}{L \times T} {\sum }_{l = 1}^{L} {\sum }_{t = 0}^{T} {𝒜}_{𝒞}^{l , t} , \qquad ( 2 )$$

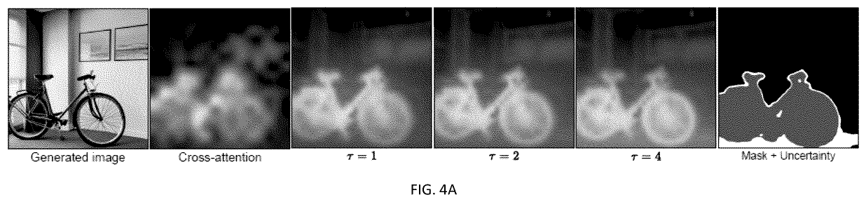

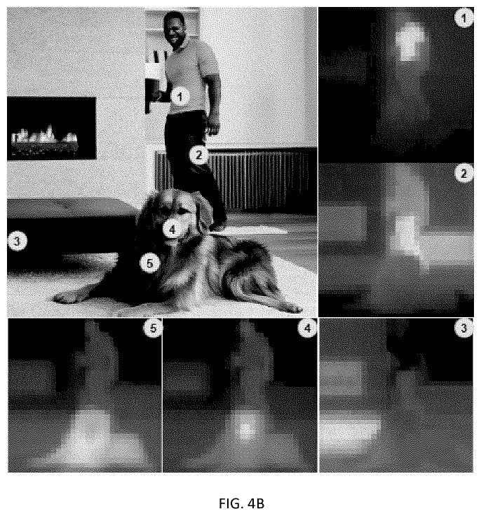

Although the cross-attention maps A_{C} already exhibit the location of the target classes in the image, they are still coarse-grained and noisy, as illustrated in FIG. 4A. Thus, the embodiments of this application propose to use the self-attention map A_{S} (as illustrated in FIG. 4B) to enhance A_{C} for a more precise object location. This is because the self-attention maps capturing the pairwise correlations among positions within the latent zₜ can help propagate the initial cross-attention maps to the highly similar positions, e.g., non-salient parts of the object, thereby enhancing their quality. Therefore, the embodiments of this application propose self-attention exponentiation where the self-attention map A_{S} is powered to r before multiplying to the cross-attention map A_{C} as:

$${𝒜}_{𝒞}^{*} = {( {𝒜}_{𝒮} )}^{τ} \cdot {𝒜}_{𝒞} , {𝒜}_{𝒞}^{*} ∈ {[ 0 , 1 ]}^{HW \times M} . \qquad ( 3 )$$

See FIG. 4A, given a text prompt “A bike is parked in a room; bicycle”, the generated image, cross-attention map, enhanced cross-attention map by the self-attention with τ={1, 2, 4}described in the Eq. (3), and mask with uncertainty value (white region) by Eq. (4) and Eq. (5) are obtained.

Next, the embodiments of this application aim to identify two matrices: objectness matrix V ∈ [0, 1]H×W representing the objectness value at each location (the higher the objectness, the more likely that location contains an object), and segmentation matrix S ∈ {1, . . . , M}H×W indicating which objects in the class labels Cᵢ that each location could be. To obtain those, the embodiments of this application perform the pixel-wise arg max and max operator (over the category M dimension):

$$𝒮 = {arg max}_{m} {𝒜}_{𝒞}^{* , m} , 𝒱 = {max}_{m} {𝒜}_{𝒞}^{* , m} . \qquad ( 4 )$$

At a location x in the map V, if its value is less than a threshold, one can set its label to the background class 0. However, the embodiments of this application find that using a fixed threshold does not work for all images. Instead, the embodiments of this application use a lower threshold a for certain background decisions and a higher threshold p for certain foreground decisions. Any value that falls inside the range (α, β) expresses an uncertain mask prediction with value U=255. That is, the final mask S is illustrated in the last image of FIG. 4A and calculated as:

$${\overline{𝒮}}_{x} = \{ \begin{matrix}0 & if {𝒱}_{x} \leq α , \\ U & if α < {𝒱}_{x} < β , \\ {𝒮}_{x} & otherwise .\end{matrix} \qquad ( 5 )$$

In the third stage, the generated images and corresponding semantic segmentations are used to train a semantic segmenter with uncertainty-aware loss and the self-training technique.

Given the synthetic images I and semantic segmentation masks 9, the embodiments of this application train a semantic segmenter (with an uncertainty-aware cross-entropy loss. Specifically, for pixels marked as uncertain the embodiments of this application ignore the loss from those as: [symbol] =Σₓ [symbol] ( [symbol] ₓ≠U) [symbol] _{CE} ( [symbol] ₓ, [symbol] ₓ), where [symbol] is an indication function, [symbol] _{CE} is a cross entropy loss, and [symbol] ₓ=Φ(I) is the predicted segmentation from the synthetic image I. The embodiments of this application further enhance the segmentation mask [symbol] by the self-training technique. That is, after being trained with [symbol] , the segmenter Φ makes its own prediction on I as pseudo labels [symbol] * without uncertainty value U. Finally, the final semantic segmenter Φ* is the segmenter Φ trained again on [symbol] *.

### Examples

Datasets: The embodiments of this application evaluate the Dataset Diffusion on two datasets: PASCAL VOC 2012 and COCO 2017. The PASCAL VOC 2012 dataset has 20 object classes and 1 background class. For standard semantic segmentation evaluation, this dataset is usually augmented with the SBD dataset to have a total of 12,046 training, 1,449 validation, and 1,456 test images. The embodiments of this application additionally augment the training images with captions generated from BLIP. The COCO 2017 dataset contains 80 object classes and 1 background class with 118,288 training and 5K validation images, along with provided captions for each image. It is worth noting that the embodiments of this application only use the image-level class annotation to form the text prompts as described above. The embodiments of this application introduce the set of prepared text prompts along with the validation set of each dataset as synth-VOC and synth-COCO—the two benchmarks for evaluation of semantic segmentation dataset synthesis. To create a balance synthetic dataset among classes, the embodiments of this application generate 2k images per object class for PASCAL VOC, resulting in a total of 40 k image-mask pairs and about 1 k images per object class for COCO, resulting in a total of 80 k image-mask pairs. If the number of text prompts associated with a certain class is insufficient, the embodiments of this application use more random seeds to generate more images.

Evaluation metric: The embodiments of this application evaluate the performance of Dataset Diffusion using the mean Intersection over Union (mIoU) metric. The mIoU (%) score measures the overlap between the predicted segmentation masks and the ground truth masks for each class and takes the average across all classes.

Implementation details: The embodiments of this application build the framework on PyTorch deep learning framework and Stable Diffusion version 2.1-base with T=100 denoising steps. The embodiments of this application construct the masks using optimal values for τ, α, and β, which are defined above. Regarding semantic segmenter, the embodiments of this application employ the DeepLabV3 and Mask2Former segmenter implemented in the MMSegmentation framework. The embodiments of this application use the AdamW optimizer with a learning rate of 1e⁻⁴ and weight decay of 1e⁻⁴. For other hyper-parameters, the embodiments of this application follow standard settings in MMSegmentation.

### Main Results

Quantitative results: Table 1 compares the results of DeepLabV3 and Mask2Former trained on the real training set, a synthetic dataset of DiffuMask, and the synthetic dataset of Dataset Diffusion.

TABLE 1
Comparison in mIoU between training DeepLabV3 and Mask2Former
on the real training set, the synthetic dataset of DiffuMask,
and the synthetic dataset of Dataset Diffusion.

| | | VOC dataset | | | COCO dataset | |
|---|---|---|---|---|---|---|
| Segmenter | Backbone | Training set | Val | Test | Training set | Val |
| DeepLabV3 | ResNet50 | VOC's training | 77.4 | 75.2 | COCO's training | 48.9 |
| DeepLabV3 | RexNet101 | (11.5k images) | 79.9 | 79.8 | (2017: 118k images) | 54.9 |
| Mask2Former | ResNet50 | | 77.3 | 77.2 | | 57.8 |
| Mask2Former | ResNet50 | DiffuMask [δ] | 57.4 | — | — | — |
| | | (60k images) | | | | |
| DeepLabV3 | RexNet50 | Dataset | 61.6 | 59.0 | Dataset | 32.4 |
| DeepLabV3 | ResNet101 | Diffusion | 64.8 | 64.6 | Diffusion | 34.2 |
| Mask2Former | ResNet50 | (40k images) | 60.2 | 60.5 | (80k images) | 31.0 |

On VOC, the embodiments of this application yields satisfactory results of 64.8 mIoU when compared to the real training set of 79.9 mIoU. Further, the embodiments of this application outperforms DiffuMask by a large margin of 4.2 mIoU using the same Resnet50 backbone. Also, Dataset Diffusion achieves a promising result of 34.2 mIoU compared to 54.9 mIoU of real COCO training set. These results demonstrate the effectiveness of Dataset Diffusion, although the gaps with the real dataset are still substantial, i.e., 15 mIoU in VOC and 20 mIoU in COCO. This is due to the fact that the image content of COCO is more complex than that of VOC, reducing the ability of Stable Diffusion to produce images with the same level of complexity.

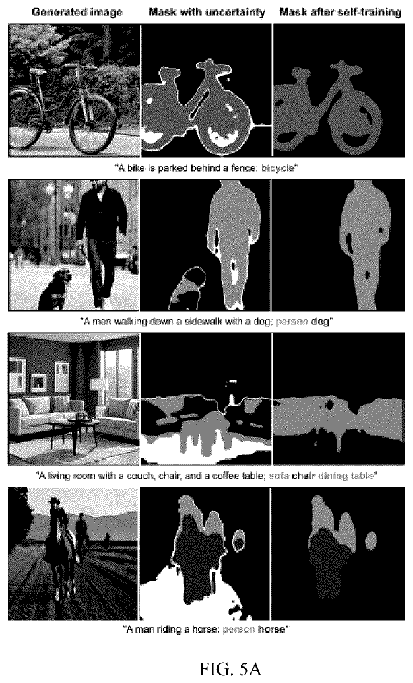

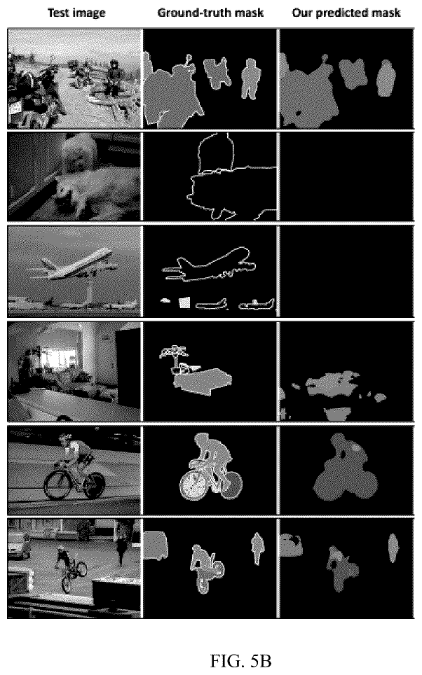

Qualitative results on the validation set of VOC are shown in FIG. 5. In FIG. 5A, the synthetic images and their corresponding masks are utilized for training the semantic segmenter. The first two rows (1, 2) serve as excellent examples of successful segmentation, while the last two rows (3, 4) demonstrate failure cases. In certain instances, the self-training technique proves effective in rectifying mis-segmented objects (as seen in rows 2 and 3). However, it can also adversely impact the original masks when dealing with objects of small size (as observed in row 4). In FIG. 5B, predicted segmentation results of the embodiments of this application on the validation set of VOC exhibit varying outcomes. The first three rows exhibit satisfactory results, with the predicted masks closely aligning with the ground truth. Conversely, the last three rows illustrate failure cases resulting from multiple small objects (row 4) and the presence of intertwined objects (rows 5 and 6).

### Ablation Study

The embodiments of this application conduct all ablation study experiments on the text prompts described above. Additionally, the embodiments of this application report the results with 20k images using the initial mask generated by Dataset Diffusion without using the self-training technique or test-time augmentation unless indicated in each experiment.

Effect of text prompt selection. Table 2 compares different text prompt selection methods.

TABLE 2
Performance of different text prompt selections. Dash line: class names, solid line: similar terms.

| Method | Example | mIoU (%) |
|---|---|---|
| 1: Simple text prompts | 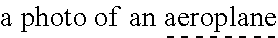 | 54.7 |
| 2: Captions only | 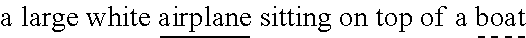 | 50.8 |
| 3: Class labels only | 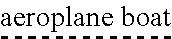 | 57.4 |
| 4: Simple text prompts + class labels | 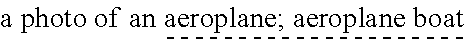 | 57.6 |
| 5: Caption + class labels | 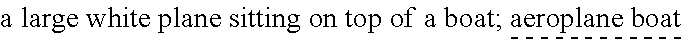 | 62.0 |

The class-prompt appending technique outperforms the text prompts using captions or class labels only. Specifically, the class-prompt appending technique increases the performance by 11.2 and 4.6 mIoU over the “caption-only” and “class-label-only” text prompts, respectively. Class-prompt appending also outperforms the simple text prompts by 7.3 mIoU. These results indicate that text prompt selection method of the embodiments of this application can help SD generate datasets with both diversity and accurate attention.

Effects of different components of stage 2 and stage 3 in FIG. 2 on the overall performance are summarized in Table 3. Using only cross-attention results in a low performance of 44.8 mIoU as the cross-attention map is coarse and inaccurate (as illustrated in FIG. 4A). Using self-attention refinement boosts the performance significantly to 61.0 mIoU. Also, using other techniques like uncertainty aware loss, self-training, and test time augmentation help improve performance incrementally.

TABLE 3
Impact of cross-attention, self-attention, uncertainty,
self-training, and test time augmentation (TTA). TTA
includes multi-scale and input flipping at test time.

| Cross- | Self- | | Self- | | |
|---|---|---|---|---|---|
| attention | attention | Uncertainty | training | TTA | mIoU (%) |
| ✓ | | | | | 44.8 |
| ✓ | ✓ | | | | 61.0 |
| ✓ | ✓ | ✓ | | | 62.0 |
| ✓ | ✓ | ✓ | ✓ | | 62.7 |
| ✓ | ✓ | ✓ | ✓ | ✓ | 64.3 |

Effect of different feature scales used for aggregating self-attention and cross-attention maps is shown in Table 4.

TABLE 4
Study on different feature scales

Self-attention

| Cross-attention | 32 | 64 |
|---|---|---|
| 8 | 39.7 | 38.1 |
| 16 | 62.0 | 59.6 |
| 32 | 52.8 | 50.9 |
| 64 | 35.4 | 31.5 |
| 16, 32 | 59.7 | 57.3 |
| 16, 32, 64 | 59.1 | 57.2 |

As can be seen, for the cross-attention map, choosing too small and too large feature scales both hurt the performance since the former lacks details while the latter focuses on fine details instead of object shape. For the self-attention map, using the scale of 32 gives slightly better results.

Hyper-parameters selection for mask generation. Sensitivity analysis is conducted on τ, α, and β to determine the optimal values in Table 5.

TABLE 5
Hyper-parameters for mask generation.
(a) Analysis of τ with α = 0.5 and β = 0.6

| τ | 0 | 1 | 2 | 3 | 4 | 5 |
|---|---|---|---|---|---|---|
| mIoU (%) | 44.8 | 59.5 | 60.5 | 60.2 | 62.0 | 60.5 |

(b) Analysis of (α, β) given τ = 4

| α-β | 0.4-0.5 | 0.5-0.6 | 0.4-0.6 |
|---|---|---|---|
| mIoU (%) | 59.5 | 62.0 | 60.7 |

Table 5(a) shows the results of choosing τ (with fixed α=0.5, β=0.6) with the best result with τ=4. A too-large value of τ=5 decreases the performance as the refined cross-attention map tends to spread out the whole image rather than the object only. Additionally, Table 5(b) exhibits the analysis on the (α, β) range given the fixed τ=4, the range of (0.5-0.6) achieves the best performance of 62.0 mIoU.

1. A method for generating a synthetic image and a semantic segmentation mask thereof, comprising:
generating, by a language model, a text prompt, wherein the text prompt comprises a caption and class labels; and
generating, by a diffusion model, the synthetic image and the semantic segmentation mask thereof based on the text prompt.

2. The method of claim 1, wherein the generating, by the diffusion model, the synthetic image and the semantic segmentation mask thereof based on the text prompt comprises:
encoding, by a text encoder, the text prompt into a text embedding; and
outputting, by the diffusion model, a final latent state reflecting a content encoded in the text embedding from an initial latent state after a predetermined number of denoising steps, wherein the diffusion model comprises a predetermined number of self-attention and cross-attention layers, at each denoising step, the self-attention and cross-attention layers transform a latent state of a current step to a latent state of a next step.

3. The method of claim 2, wherein the initial latent state follows N(0,1), which is a standard Gaussian distribution.

4. The method of claim 3, wherein the transforming, at each denoising step, the latent state of the current step to the latent state of the next step comprises:
generating, by each self-attention layer, a self-attention map for capturing a pairwise similarity between positions within a latent state of the current layer in order to enhance a local feature with a global context in a latent state of next layer; and
generating, by each cross-attention layer, a cross-attention map for modeling the relationship between each position of the latent state of the current layer and each token of the text embedding so that the latent state of the next layer expresses more of the content encoded in the text embedding.

5. The method of claim 4, wherein the generating, by each cross-attention layer, the cross-attention map, comprises:
generating a class-specific text prompt based on each class label; and
generating the cross-attention map based on the class-specific text prompts.

6. The method of claim 5, further comprising
averaging the cross-attention maps over layers and steps to generate an average cross-attention map;
averaging the self-attention maps over layers and steps to generate an average self-attention map; and
enhancing the average cross-attention map based on the average self-attention map.

7. The method of claim 6, wherein the enhancing the average cross-attention map based on the average self-attention map comprises:
powering the average self-attention map to a predetermined exponent to generate a powered self-attention map; and
multiplying the powered self-attention map to the average cross-attention map to generate an enhanced cross-attention map.

8. The method of claim 7, further comprising:
generating an objectness matrix based on the enhanced cross-attention map, wherein the objectness matrix comprises an objectness value at each location, wherein the higher the objectness value, the more likely that location contains an object; and
generating a segmentation matrix based on the enhanced cross-attention map, wherein the segmentation matrix comprises a segmentation value at each location indicating which objects in the class labels that each location could be.

9. The method of claim 8, wherein the generating the semantic segmentation mask comprises, at a location in the objectness matrix:
determining whether the objectness value of the location is less than or equal to a first threshold, in response to determining the objectness value of the location is less than or equal to the first threshold, setting a label of the location to background;
determining whether the objectness value of the location is greater than or equal to a second threshold, wherein the second threshold is greater than the first threshold, in response to determining the objectness value of the location is greater than or equal to the second threshold, setting the label of the location to a class of the corresponding location of the segmentation matrix; and
determining whether the objectness value of the location is greater than the first threshold and less than the second threshold, in response to determining the objectness value of the location is greater than the first threshold and less than the second threshold, setting the label of the location to uncertainty.

10. The method of claim 9, further comprising:
training a semantic segmenter Φ based on the generated synthetic image I and the semantic segmentation mask [symbol] thereof with an uncertainty-aware cross-entropy loss, wherein for pixels marked as uncertain, ignoring the loss from those as: [symbol] =Σₓ [symbol] ( [symbol] ₓ≠U) [symbol] _{CE}( [symbol] ₓ, [symbol] ₓ), where [symbol] is an indication function, [symbol] _{CE} is a cross entropy loss, and [symbol] ₓ=Φ(I) is the predicted segmentation from the synthetic image I;
predicting, by the semantic segmenter, on synthetic image I as pseudo labels [symbol] * without uncertainty value U; and
training the semantic segmenter based on pseudo labels [symbol] * to generate a final semantic segmenter Φ*.

11. A system for generating a synthetic image and a semantic segmentation mask thereof comprising:
one or more processors; and
a computer-readable medium having instructions stored there on, which, when executed by the one or more processors, cause the system to perform operations comprising:
generating, by a language model, a text prompt, wherein the text prompt comprises a caption and class labels; and
generating, by a diffusion model, the synthetic image and the semantic segmentation mask thereof based on the text prompt.

12. The system of claim 11, wherein the generating, by the diffusion model, the synthetic image and the semantic segmentation mask thereof based on the text prompt comprises:
encoding, by a text encoder, the text prompt into a text embedding; and
outputting, by the diffusion model, a final latent state reflecting a content encoded in the text embedding from an initial latent state after a predetermined number of denoising steps, wherein the diffusion model comprises a predetermined number of self-attention and cross-attention layers, at each denoising step, the self-attention and cross-attention layers transform a latent state of a current step to a latent state of a next step.

13. The system of claim 12, wherein the transforming, at each denoising step, the latent state of the current step to the latent state of the next step comprises:
generating, by each self-attention layer, a self-attention map for capturing a pairwise similarity between positions within a latent state of the current layer in order to enhance a local feature with a global context in a latent state of next layer; and
generating, by each cross-attention layer, a cross-attention map for modeling the relationship between each position of the latent state of the current layer and each token of the text embedding so that the latent state of the next layer expresses more of the content encoded in the text embedding.

14. The system of claim 13, wherein the generating, by each cross-attention layer, the cross-attention map, comprises:
generating a class-specific text prompt based on each class label; and
generating the cross-attention map based on the class-specific text prompts.

15. The system of claim 14, wherein the instructions further cause the system to perform the operations of:
averaging the cross-attention maps over layers and steps to generate an average cross-attention map;
averaging the self-attention maps over layers and steps to generate an average self-attention map; and
enhancing the average cross-attention map based on the average self-attention map.

16. The system of claim 15, wherein the enhancing the average cross-attention map based on the average self-attention map comprises:
powering the average self-attention map to a predetermined exponent to generate a powered self-attention map; and
multiplying the powered self-attention map to the average cross-attention map to generate an enhanced cross-attention map.

17. The system of claim 16, wherein the instructions further cause the system to perform the operations of:
generating an objectness matrix based on the enhanced cross-attention map, wherein the objectness matrix comprises an objectness value at each location, wherein the higher the objectness value, the more likely that location contains an object; and
generating a segmentation matrix based on the enhanced cross-attention map, wherein the segmentation matrix comprises a segmentation value at each location indicating which objects in the class labels that each location could be.

18. The system of claim 17, wherein the generating the semantic segmentation mask comprises, at a location in the objectness matrix:
determining whether the objectness value of the location is less than or equal to a first threshold, in response to determining the objectness value of the location is less than or equal to the first threshold, setting a label of the location to background;
determining whether the objectness value of the location is greater than or equal to a second threshold, wherein the second threshold is greater than the first threshold, in response to determining the objectness value of the location is greater than or equal to the second threshold, setting the label of the location to a class of the corresponding location of the segmentation matrix; and
determining whether the objectness value of the location is greater than the first threshold and less than the second threshold, in response to determining the objectness value of the location is greater than the first threshold and less than the second threshold, setting the label of the location to uncertainty.

19. The system of claim 18, wherein the instructions further cause the system to perform the operations of:
training a semantic segmenter Φ based on the generated synthetic image I and the semantic segmentation mask [symbol] thereof with an uncertainty-aware cross-entropy loss, wherein for pixels marked as uncertain, ignoring the loss from those as: [symbol] =Σₓ [symbol] ( [symbol] ₓ≠U) [symbol] _{CE} ( [symbol] ₓ, [symbol] ₓ), where [symbol] is an indication function, [symbol] _{CE} is a cross entropy loss, and [symbol] ₓ=Φ(I) is the predicted segmentation from the synthetic image I;
predicting, by the semantic segmenter, on synthetic image I as pseudo labels [symbol] without uncertainty value U; and
training the semantic segmenter based on pseudo labels [symbol] * to generate a final semantic segmenter Φ*.

20. A non-transitory computer-readable storage medium comprising instructions that, when executed by at least one processor of a machine, cause the machine to perform the method of claim 1.
